(19) United States
(12) Patent Application Publication
(10) Pub. No.: US 2011/0261135 A1
(43) Pub. Date: Oct. 27, 2011

(54) THERMAL HEAD PRINTER

(75) Inventor: Katsuhisa ONO, Tokyo (JP)

(73) Assignee: Sony Corporation, Tokyo (JP)

(21) Appl. No.: 13/080,038

(22) Filed: Apr. 5, 2011

(30) Foreign Application Priority Data
Apr. 23, 2010 (JP) 2010-100047

(51) Int. Cl. B41J 32/00

(52) U.S. Cl. 347/214

(57) ABSTRACT

A thermal head printer includes: a cassette in which print paper is loaded; a transfer part, having a platen roller, that transfers the print paper; an ejecting part from which the print paper is ejected; a ribbon drive part that supplies an ink ribbon; a head mechanism, having a print head, that is moved among at least three positions, which are a first position, a second position, and a third position; a first drive cam that moves the head mechanism between the first position and second position; and a second drive cam that moves the head mechanism between the second position and third position. An amount by which the head mechanism moves over a distance between the second position and third position is smaller than between the first position and second position. The second drive cam has a smaller outside shape than the first drive cam.

### BACKGROUND OF THE INVENTION

1. Field of the Invention

The present invention relates to a thermal head printer and, more particularly, to a thermal head printer having a first drive cam and a second drive cam that move a head mechanism so that the operation of the head mechanism is fastened.

2. Description of the Related Art

A thermal head printer is a type of printer that forms a printed image on print paper by pressing a print head against an ink ribbon and sublimating ink coated onto the ink ribbon.

This type of thermal head printer includes a head mechanism, which has the print head, and a head moving mechanism that moves the head mechanism toward and away from the ink ribbon and print paper.

The head mechanism is movable among a printing position at which the print head is pressed against the ink ribbon and print paper at the time of printing, a standby position at which the head mechanism is placed in a ready state before printing starts, and an evacuation position at which parts of the head mechanism can be serviced. The distance between the printing position and standby position is short so that printing on print paper can be quickly carried out. The distance between the standby position and evacuation position is long so that the head mechanism can be easily accessed.

With some thermal head printers of this type, the head moving mechanism configured to move the head mechanism has a single drive cam, which is operated to enable the head mechanism to move among the printing position, standby position, and evacuation position.

When a single drive cam is used to move the head mechanism, however, a drive part such as a cam groove configured to move the head mechanism between the printing position and standby position and another drive part such as a cam groove configured to move the head mechanism between the standby position and evacuation position are formed in the single drive cam.

This type of drive cam has large outside shape and thereby is heavy, slowing the operation of the drive cam accordingly. This prevents the head mechanism from moving at high speed.

Since the distance between the printing position and standby position is shorter than the distance between the standby position and evacuation position, as described above, the use of the single drive cam to move the head mechanism among the three positions causes another problem; when the head mechanism is moved between the printing position and standby position, that is, over the shorter distance, positional precision is lowered.

A head moving mechanism in a thermal head printer described in, for example, Japanese Unexamined Patent Application Publication No. 2009-285980, has two drive bodies in the head moving mechanism. A first drive body moves the head mechanism between the standby position and evacuation position, and a second drive body moves the head mechanism between the printing position and standby position.

### SUMMARY OF THE INVENTION

In the thermal head printer described in Japanese Unexamined Patent Application Publication No. 2009-285980, the first drive body is formed with a rack and a pinion, and the second drive body is formed with an eccentric cam and a cam pin. The pinion and eccentric cam are rotatably supported by the head mechanism.

Since the head mechanism, pinion, and eccentric cam are moved between the printing position and evacuation position, the weight of the head mechanism is increased by the amount of the pinion and eccentric cam, preventing the head mechanism from moving at high speed.

It is desirable to fasten the operation of the head mechanism of a thermal head printer.

According to an embodiment of the present invention, there is provided a thermal head printer that includes a cassette in which print paper is loaded, a transfer part configured to feed the print paper from the cassette and transfer the print paper, the transfer part having a platen roller with which the print paper comes into contact at least at the time of printing, an ejecting part from which the print paper is ejected after printing, a ribbon drive part configured to supply an ink ribbon loaded therein, a head mechanism having a print head that is pressed against the ink ribbon and sublimates ink coated onto the ink ribbon to form a printed image on the print paper, the head mechanism being moved among at least three move-to positions, which are a first move-to position, a second move-to position, and a third move-to position, a first drive cam configured to move the head mechanism between the first move-to position and second move-to position, and a second drive cam configured to move the head mechanism between the second move-to position and third move-to position; an amount by which the head mechanism moves over a distance between the second move-to position and third move-to position is smaller than between the first move-to position and second move-to position; the second drive cam has a smaller outside shape than the first drive cam.

Therefore, the thermal head printer is structured so that movement of the head mechanism over the larger distance between the evacuation position and a standby position is carried out by the first drive cam, and movement of the head mechanism over the shorter distance between the standby position and printing position is carried out by the second drive cam, which has a smaller outside shape than the first drive cam.

In the above thermal head printer, the first move-to position is preferably the evacuation position at which the print head is apart from the platen roller, the second move-to position is preferably the standby position at which the print head is apart from the platen roller but the print head is closer to the platen roller than at the evacuation position, and the third move-to position is preferably the printing position at which the print head is pressed against the print paper and holds the print paper together with the platen roller with the print paper interposed therebetween.

The first move-to position is the evacuation position, the second move-to position is the standby position, and the third move-to position is printing position, as described above. Then, movement between the evacuation position and standby position is carried out by the first drive cam, and movement between the standby position and printing position is carried out by the second drive cam.

In the above thermal head printer, the head mechanism is preferably swingable and the head mechanism is preferably swung by the rotation of the first drive cam and second drive cam.

Since the head mechanism is swingable, the head mechanism is swung by the rotation of the first drive cam and second drive cam, so a space in which the head mechanism, first drive cam, and second drive cam move is reduced.

In the above thermal head printer, the head mechanism preferably has a cam axis, the first drive cam preferably has a cam groove to which the cam axis of the head mechanism can be slidably fitted, and the cam groove of the first drive cam preferably has an opening through which the cam axis of the head mechanism comes off the cam groove of the first drive cam when the head mechanism is moved by the second drive cam between the second move-to position and third move-to position.

Since the opening is formed through which the cam axis comes off the cam groove of the first drive cam when the head mechanism is moved by the second drive cam between the second move-to position and third move-to position, a load is not applied from the first drive cam to the head mechanism when the head mechanism is swung between the second move-to position and third move-to position.

In the above thermal head printer, the head mechanism preferably has a fitting axis, the second drive cam preferably has a cam sliding part, the head mechanism preferably has a link mechanism that includes a matable fitting part and also has a cam pin that can slidably fit to the cam sliding part of the second drive cam, and the fitting axis of the head mechanism preferably comes off the fitting part of the link mechanism when the head mechanism is moved by the first drive cam between the first move-to position and second move-to position.

Since the fitting axis comes off the fitting part of the link mechanism when the head mechanism is moved by the first drive cam between the first move-to position and second move-to position, a load is not applied from the second drive cam to the head mechanism when the head mechanism is swung between the first move-to position and second move-to position.

The thermal head printer according to an embodiment of the present invention includes a cassette in which print paper is loaded, a transfer part configured to feed the print paper from the cassette and transfer the print paper, the transfer part having a platen roller with which the print paper comes into contact at least at the time of printing, an ejecting part from which the print paper is ejected after printing, a ribbon drive part configured to supply an ink ribbon loaded therein, a head mechanism having a print head that is pressed against the ink ribbon and sublimates ink coated onto the ink ribbon to form a printed image on the print paper, the head mechanism being moved among at least three move-to positions, which are a first move-to position, a second move-to position, and a third move-to position, a first drive cam configured to move the head mechanism between the first move-to position and second move-to position, and a second drive cam configured to move the head mechanism between the second move-to position and third move-to position; an amount by which the head mechanism moves over a distance between the second move-to position and third move-to position is smaller than between the first move-to position and second move-to position; the second drive cam has a smaller outside shape than the first drive cam.

Since movement of the head mechanism over the shorter distance between the second move-to position and third move-to position is carried out by the second drive cam having a small outside shape, the rotational speed of the second drive cam can be increased and thereby the head mechanism can be moved at high speed.

Since the head mechanism is swung between the first move-to position and third move-to position without the pinion, the cam, and other heavy parts being supported by the head mechanism, the weight of the head mechanism is not increased and thereby the movement of the head mechanism can be fastened accordingly.

In an embodiment of the present invention, the first move-to position is the evacuation position at which the print head is apart from the platen roller, the second move-to position is the standby position at which the print head is apart from the platen roller but the print head is closer to the platen roller than at the evacuation position, and the third move-to position is the printing position at which the print head is pressed against the print paper and holds the print paper together with the platen roller with the print paper interposed therebetween.

Accordingly, the swing movement of the head mechanism is fastened between the standby position, which is a ready position before printing starts, and the printing position, which is effected at the time of printing, and thereby operation until printing starts can be fastened.

In another embodiment of the present invention, since the head mechanism is swingable, the head mechanism is swung by the rotation of the first drive cam and second drive cam.

Accordingly, a space in which the head mechanism, first drive cam, and second drive cam move can be reduced, enabling the thermal head printer to be made compact.

In still another embodiment of the present invention, the head mechanism has a cam axis, the first drive cam has a cam groove to which the cam axis of the head mechanism can be slidably fitted, and the cam groove of the first drive cam has an opening through which the cam axis of the head mechanism comes off the cam groove of the first drive cam when the head mechanism is moved by the second drive cam between the second move-to position and third move-to position.

Accordingly, a load is not applied from the first drive cam to the head mechanism when the head mechanism is swung by the second drive cam between the second move-to position and third move-to position, enabling the head mechanism to swing smoothly between the second move-to position and third move-to position at high speed.

In yet another embodiment of the present invention, the head mechanism has a fitting axis, the second drive cam has a cam sliding part, the head mechanism has a link mechanism that includes a matable fitting part and also has a cam pin that can slidably fit to the cam sliding part of the second drive cam, and the fitting axis of the head mechanism comes off the fitting part of the link mechanism when the head mechanism is moved by the first drive cam between the first move-to position and second move-to position.

Accordingly, a load is not applied from the second drive cam to the head mechanism when the head mechanism is swung by the first drive cam 25 between the first move-to position and second move-to position, enabling the head mechanism to swing smoothly between the first move-to position and second move-to position at high speed.

### BRIEF DESCRIPTION OF THE DRAWINGS

FIG. 1 is a schematic side view of a thermal head printer according to an embodiment of the present invention.

FIG. 2 is a schematic side view when a head mechanism of the thermal head printer according to the embodiment is placed at an evacuation position.

FIG. 3 is a schematic side view when the head mechanism of the thermal head printer according to the embodiment is placed at a standby position.

FIG. 4 is a schematic side view when the head mechanism of the thermal head printer according to the embodiment is placed at a printing position.

### DESCRIPTION OF THE PREFERRED EMBODIMENTS

A thermal head printer according to an embodiment of the present invention will be described below with reference to the attached drawings.

### Structure of the Thermal Head Printer

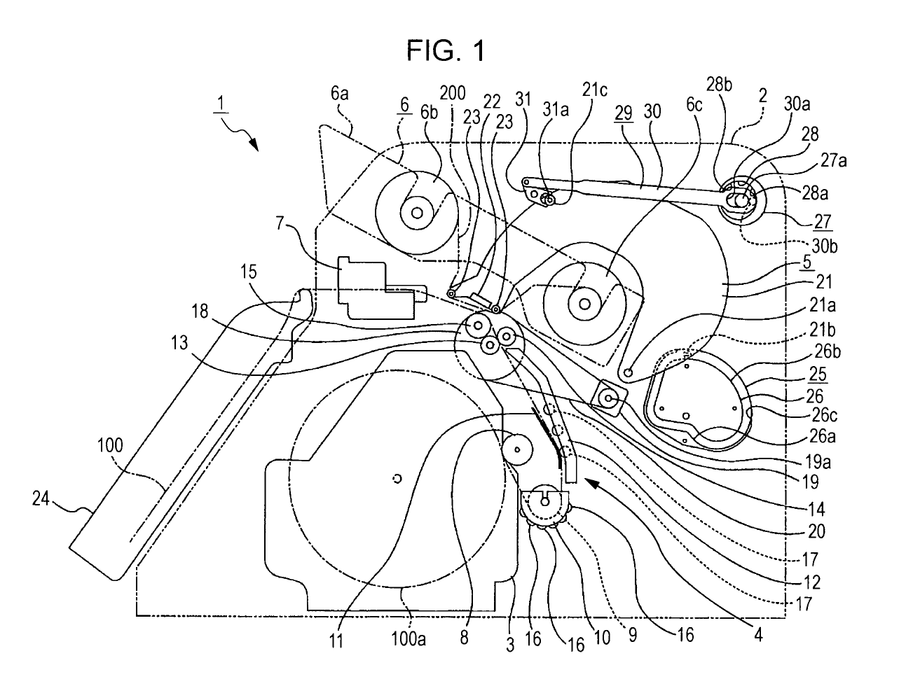

A thermal head printer 1 has parts where necessary inside and outside an external case 2 (see FIG. 1).

A cassette 3, a transfer part 4, a head mechanism 5, a ribbon drive part 6, and a cutter mechanism 7 are provided in the external case 2.

The cassette 3, disposed at the bottom of the external case 2, is loaded with print paper 100 wound in a roll shape. A roll part 100a of the print paper 100 loaded in the cassette 3 is rotatable with respect to the cassette 3.

The transfer part 4 includes a paper feed roller 8, a turnback roller 9, a feed guide 10, guides 11 and 12, a capstan 13, a pinch roller 14, and a platen roller 15.

The paper feed roller 8 is made of, for example, a rubber material. It is rotated by a motor (not shown) in the vicinity of an outlet from which the print paper 100 is drawn from the cassette 3. When the paper feed roller 8 rotates, the print paper 100 is drawn from the cassette 3 and transferred.

The turnback roller 9, which is rotatably supported below the paper feed roller 8, turns over the print paper 100, fed by the paper feed roller 8, through approximately 180 degrees in a U shape and transfers the print paper 100. A space in which to form a transfer path for the print paper 100 can be reduced by the use of the turnback roller 9, enabling the thermal head printer to be made compact. Furthermore, the print paper 100 can be reversed by the use of the turnback roller 9, enabling the cassette 3 and an ejection part (output tray), which will be described later, to be oriented in a desired direction. The freedom of design and operability can thereby be improved.

The turnback roller 9 is rotatably supported by the feed guide 10. A plurality of feed rollers 16 is disposed on the feed guide 10 along the outer circumference of the turnback roller 9 so as to be rotatably supported.

The guides 11 and 12 are oppositely disposed above the turnback roller 9. A plurality of feed rollers 17 is disposed on the guide 12 along the transfer path for the print paper 100 so as to be rotatably supported.

The capstan 13 is fixed at the center of a pulley 18 provided concentrically with the capstan 13. The capstan 13 is rotated by the driving force of a drive motor 19. A driving force transmission belt 20 runs between the pulley 18 and the motor axis 19a of the drive motor 19. Thus, the capstan 13 is rotated when the driving force of the drive motor 19 is transmitted thereto through the driving force transmission belt 20 and pulley 18.

The pinch roller 14 is brought into contact with the capstan 13 with the print paper 100 interposed therebetween. The pinch roller 14 is rotated by the rotation of the capstan 13 and transfers the print paper 100 while holding it together with the capstan 13.

The platen roller 15 is disposed near the pinch roller 14. When the head mechanism 5 is operated at the time of printing on the print paper 100, the print paper 100 is pressed against the platen roller 15.

The head mechanism 5 includes a swingably supported heat sink 21, a print head 22 provided at an end of the heat sink 21, and two ribbon rollers 23 provided at the end of the heat sink 21 and the front and back of the print head 22.

The heat sink 21 dissipates heat that is generated, during printing, by a plurality of heat generation elements provided in the print head 22 when the heat generation elements are turned on. The heat sink 21 has a swingable fulcrum 21a at an end opposite to the side on which the print head 22 is disposed, and also has a cam axis 21b and a fitting axis 21c, which laterally project.

The cam axis 21b is disposed near the swingable fulcrum 21a, and the fitting axis 21c is disposed near the print head 22.

The ribbon drive part 6 supplies an ink ribbon 200 at the time of printing. The ribbon drive part 6 includes a ribbon tray 6a as well as a supply reel 6b and a take-up reel 6c, which are separately supported by the ribbon tray 6a so as to be rotatable.

The ink ribbon 200 is supplied from the supply reel 6b and taken up onto the take-up reel 6c. When the print head 22 approaches the print paper 100 due the operation of the head mechanism 5, the ink ribbon 200 is pressed by the two ribbon rollers 23 and pushed toward the print paper 100. Part of the ink ribbon 200 between the two ribbon rollers 23 is pressed against the print paper 100 from a side opposite to the platen roller 15. In the ribbon drive part 6, the take-up reel 6c is rotated by the driving force of a ribbon supply motor (not shown), and the ink ribbon 200 is supplied from the supply reel 6b.

The cutter mechanism 7 has a cutter to cut the print paper 100 on which printing has been completed, at a predetermined position.

An output tray 24, which functions as the ejection part, is provided on the external case 2. After printing on the print paper 100 by the print head 22 has been completed and the printer paper 100 has been cut by the cutter, the cut print paper 100 is ejected onto the output tray 24.

In the external case 2, a first drive cam 25 is rotatably supported. The first drive cam 25 has a cam groove 26 annularly formed around its outer circumference. The cam groove 26 has a displaced part 26a formed in a substantially L-shape and also has a non-displaced part 26b formed in a substantially arcuate so as to be continuous to the displaced part 26a and to be centered around the rotational center of the first drive cam 25. The first drive cam 25 has an opening 26c, which is open toward the outside, in the non-displaced part 26b of the cam groove 26.

The cam axis 21b disposed in the heat sink 21 of the head mechanism 5 can slidably fit the cam groove 26 of the first drive cam 25.

In the external case 2, a second drive cam 27 formed in a discoid shape is rotatably supported. The second drive cam 27 has a smaller outside shape than the first drive cam 25, and includes a linkage projection 27a, which laterally projects, at the center. The second drive cam 27 internally has a cam sliding part 28. The cam sliding part 28 includes a first cam 28a, the distance of which from the rotational center of the second drive cam 27 varies, and a second cam 28b formed in an arcuate shape so as to be centered around the rotational center of the second drive cam 27.

A link mechanism 29 is linked to the second drive cam 27. The link mechanism 29 includes a linkage arm 30, which is linear, and a fitting lever 31 supported at one end of the linkage arm 30 so as to be swingable.

The linkage arm 30 has a linkage hole 30a, which is long in the longitudinal direction, near the other end. The linkage projection 27a of the second drive cam 27 slidably fits the linkage hole 30a. A cam pin 30b, which laterally projects, is provided at the other end of the linkage arm 30. The cam pin 30b slidably fits the cam sliding part 28 of the second drive cam 27. The linkage arm 30 is urged backward by a spring (not shown).

The fitting lever 31 has a fitting part 31a formed in a concave shape. The fitting part 31a can slidably fit to the fitting axis 21c disposed on the heat sink 21 of the head mechanism 5. The fitting lever 31 is swingable around its substantially central part.

### Printing Operation of the Thermal Head Printer

With the thermal head printer 1 structured as described above, the print paper 100 is taken out of the cassette 3 and sent toward the output tray 24 due to the rotation of the paper feed roller 8, after which the direction in which the print paper 100 is transferred is reversed by the turnback roller 9. Then, the print paper 100 is guided by the feed guide 10 and the guides 11 and 12 and transferred toward the output tray 24 by the rotation of the capstan 13. In this process, the print paper 100 is smoothly transferred while being brought into contact with the plurality of feed rollers 16 supported by the feed guide 10 and the plurality of feed rollers 17 supported by the guide 12.

While the print paper 100 is transferred on the platen roller 15, the ink ribbon 200 is supplied from the supply reel 6b and the head mechanism 5 is operated so that the print head 22 approaches the ink ribbon 200 and print paper 100. When the print head 22 approaches and touches the ink ribbon 200 and print paper 100, the plurality of heat generation elements disposed in the print head 22 is selectively turned on and driven to sublimate the ink coated onto the ink ribbon 200, starting printing on the print paper 100.

After the printing on the print paper 100 is completed, the print paper 100 is transferred toward the output tray 24, cut by the cutter driven by the cutter mechanism 7, and output to the output tray 24.

### Operation of the Head Mechanism

The head mechanism 5 is swung among the evacuation position (first move-to position) at which the print head 22 is apart from the platen roller 15, the standby position (second move-to position) at which the print head 22 is apart from the platen roller 15 but the print head 22 is closer to the platen roller 15 than at the evacuation position, and the printing position (third move-to position) at which the print head 22 holds the print paper 100 together with the platen roller 15 with the print paper 100 interposed therebetween.

The evacuation position is a position at which parts of the head mechanism can be serviced, the standby position is a position at which the head mechanism is placed in a ready state before printing starts, and the printing position is a position at which the print head 22 is pressed against the ink ribbon 200 and print paper 100 at the time of printing. An amount by which the head mechanism 5 moves over a distance between the standby position and printing position is smaller than between the evacuation position and standby position.

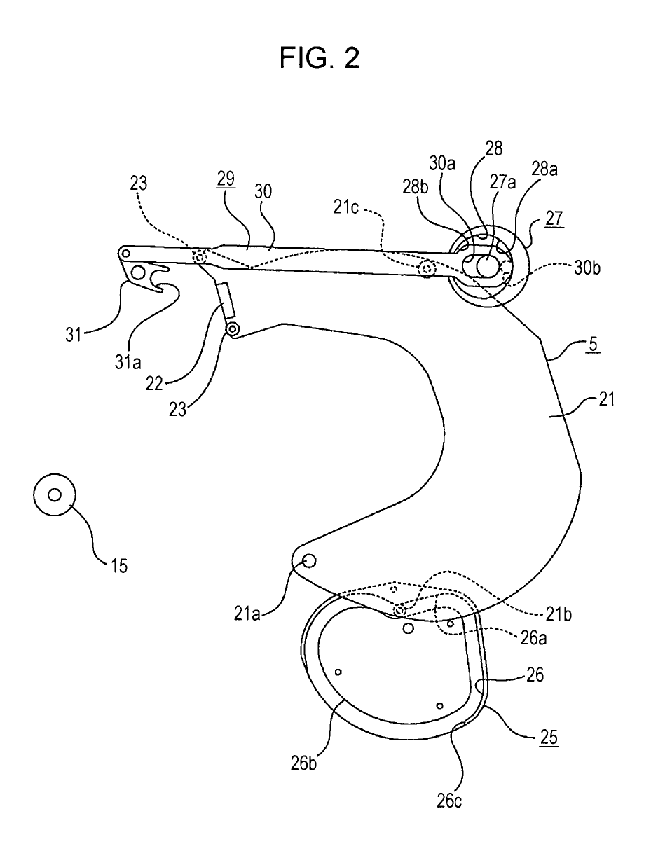

With the head mechanism 5 placed at the evacuation position, the cam axis 21b fits to the displaced part 26a in the cam groove 26 formed in the first drive cam 25, and the cam pin 30b of the linkage arm 30 of the link mechanism 29 fits to the first cam 28a of the cam sliding part 28 of the second drive cam 27, as shown in FIG. 2. In this state, the fitting part 31a of the fitting lever 31 of the link mechanism 29 is separated from the fitting axis 21c of the head mechanism 5.

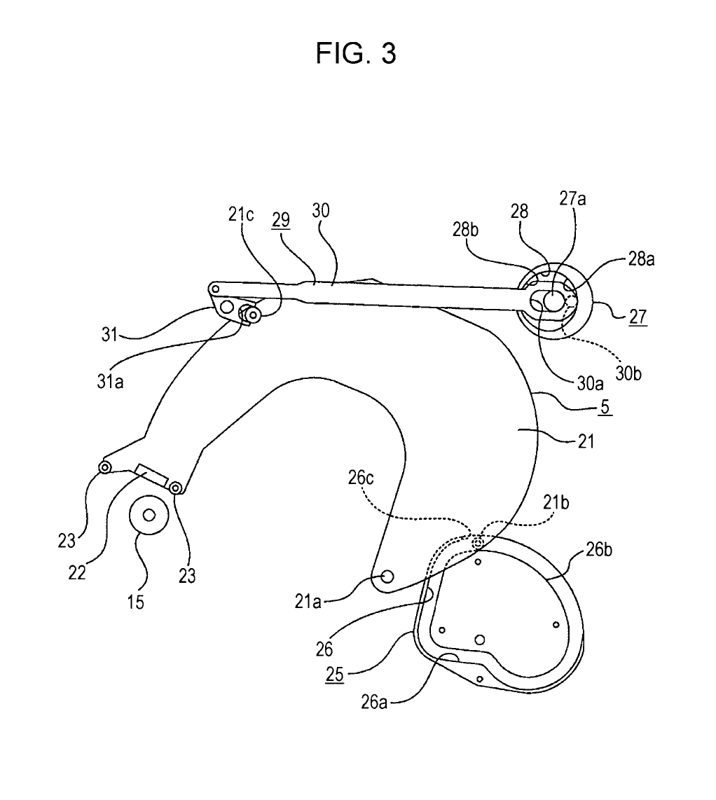

When the first drive cam 25 is rotated in a predetermined direction with the head mechanism 5 placed at the evacuation position, the cam axis 21b slides on the displaced part 26a of the cam groove 26 and fits to the non-displaced part 26b (see FIG. 3). Accordingly, the head mechanism 5 is swung in a direction in which the print head 22 moves close to the platen roller 15, and reaches the standby position. Since the second drive cam 27 is not rotated, the cam pin 30b of the linkage arm 30 remains fitting to the first cam 28a of the cam sliding part 28.

When the head mechanism 5 is swung from the evacuation position to the standby position, the fitting axis 21c is moved close to the fitting lever 31 and comes into contact with the fitting part 31a.

With the head mechanism 5 placed in the standby position, the print paper 100 is fed by the transfer part 4 to a position between the print head 22 and platen roller 15 and the ink ribbon 200 is fed from the ribbon tray 6a to a position between the print head 22 and platen roller 15.

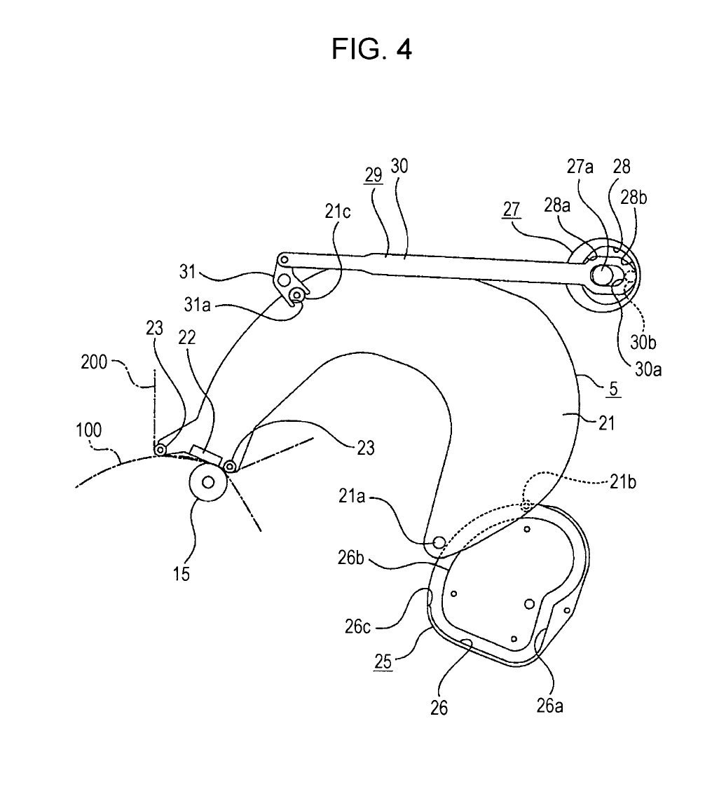

When the first drive cam 25 is further rotated in the same direction with the head mechanism 5 placed in the standby position, the cam axis 21b is externally displaced from the opening 26c and moved along the non-displaced part 26b of the cam groove 26 (see FIG. 4).

Then, the second drive cam 27 starts to rotate, by which the cam pin 30b of the linkage arm 30 continuously slides on the first cam 28a and second cam 28b of the cam sliding part 28 and fits to the second cam 28b. When the cam pin 30b of the linkage arm 30 slides on the second cam 28b of the cam sliding part 28, the linkage arm 30 is moved backward and the fitting lever 31 is swung. Therefore, the swing force of the fitting lever 31 is transmitted to the fitting axis 21c, the head mechanism 5 is swung in a direction in which the print head 22 approaches the platen roller 15, and the print head 22 is placed in the printing position by being pressed against the platen roller 15 with the ink ribbon 200 and print paper 100 interposed therebetween. At the printing position, the ink coated onto the ink ribbon 200 is sublimated, and printing on the print paper 100 is carried out, as described above.

When the first drive cam 25 is rotated in a direction opposite to the above direction with the head mechanism 5 still placed at the printing position after the printing on the print paper 100 has been completed, the cam axis 21b is moved along the non-displaced part 26b in the cam groove 26 (see FIG. 3).

Then, the second drive cam 27 also rotates, by which the cam pin 30b of the linkage arm 30 continuously slides on the second cam 28b and first cam 28a of the cam sliding part 28 and fits to the first cam 28a. When the cam pin 30b of the linkage arm 30 slides on the first cam 28a of the cam sliding part 28, the linkage arm 30 is moved forward and the fitting lever 31 is swung. Therefore, the swing force of the fitting lever 31 is transmitted to the fitting axis 21c. Then, the head mechanism 5 is swung in a direction in which the print head 22 moves apart from the platen roller 15, and the print head 22 is separated from the platen roller 15 and placed in the standby position.

When the first drive cam 25 is further rotated in the reverse direction with the head mechanism 5 placed in the standby position, the cam axis 21b slides from the non-displaced part 26b in the cam groove 26 to the displaced part 26a (see FIG. 2). Therefore, the head mechanism 5 is swung in the direction in which the print head 22 further moves apart from the platen roller 15, and reaches the evacuation position. Since the second drive cam 27 is not rotated, the cam pin 30b of the linkage arm 30 remains fitting to the first cam 28a of the cam sliding part 28.

When the head mechanism 5 is swung from the standby position to the evacuation position, the fitting axis 21c is moved apart from the fitting lever 31, detaching the fitting axis 21c from the fitting part 31a.

### CONCLUSION

As described above, with the thermal head printer 1, the first drive cam 25 having a large outside shape is used to move the head mechanism 5 over the larger distance, that is, between the first move-to position (evacuation position) and second move-to position (standby position), and the second drive cam 27 having a small outside shape is used to move the head mechanism 5 over the shorter distance, that is, between the second move-to position and third move-to position (printing position).

Since the movement of the head mechanism 5 over the shorter distance between the second move-to position and third move-to position is carried out by the second drive cam 27 having a small outside shape, the rotational speed of the second drive cam 27 can be increased and thereby the head mechanism 5 can be moved at high speed.

Since the second drive cam 27, which is different from the first drive cam 25 having a larger outside shape, is used for the movement over the shorter distance between the second move-to position and third move-to position, positional precision in the movement between the second move-to position and third move-to position can be improved.

Since the head mechanism 5 is swung between the first move-to position and third move-to position without the pinion, the cam, and other heavy parts being supported by the head mechanism 5, the weight of the head mechanism 5 is not increased and thereby the movement of the head mechanism 5 can be fastened accordingly.

Since the first move-to position is the evacuation position, the second move-to position is the standby position, and the third move-to position is printing position, the swing movement of the head mechanism is fastened between the standby position, which is a ready position before printing starts, and the printing position, which is effected at the time of printing, and thereby operation until printing starts can be fastened.

Since the head mechanism 5 is swingable, the head mechanism 5 is swung by the rotation of the first drive cam 25 and second drive cam 27, so a space in which the head mechanism 5, first drive cam 25, and second drive cam 27 move can be reduced, enabling the thermal head printer 1 to be made compact.

When the head mechanism 5 is swung by the second drive cam 27 between the standby position and printing position, the cam axis 21b of the head mechanism 5 is externally displaced from the opening 26c of the cam groove 26 formed in the first drive cam 25. Therefore, a load is not applied from the first drive cam 25 to the head mechanism 5 when the head mechanism 5 is swung by the second drive cam 27 between the standby position and printing position, enabling the head mechanism 5 to smoothly swing at high speed between the standby position and printing position.

When the head mechanism 5 is swung by the first drive cam 25 between the evacuation position and standby position, the fitting axis 21c of the head mechanism 5 comes off the fitting part 31a of the fitting lever 31 of the link mechanism 29. Therefore, a load is not applied from the first drive cam 25 to the head mechanism 5 when the head mechanism 5 is swung by the second drive cam 27 between the evacuation position and standby position, enabling the head mechanism 5 to smoothly swing at high speed between the evacuation position and standby position.

The present application contains subject matter related to that disclosed in Japanese Priority Patent Application JP 2010-100047 filed in the Japan Patent Office on Apr. 23, 2010, the entire contents of which are hereby incorporated by reference.

The specific shapes and structures of the parts indicated above are just examples to make the embodiment of the present invention concrete. It should be understood that these shapes and structures do not limit the technical range of the invention.

What is claimed is:

1. A thermal head printer, comprising:
a cassette in which print paper is loaded;
a transfer part configured to feed the print paper from the cassette and transfer the print paper, the transfer part having a platen roller with which the print paper comes into contact at least at a time of printing;
an ejecting part from which the print paper is ejected after printing;
a ribbon drive part configured to supply an ink ribbon loaded therein;
a head mechanism having a print head that is pressed against the ink ribbon and sublimates ink coated onto the ink ribbon to form a printed image on the print paper, the head mechanism being moved among at least three move-to positions, which are a first move-to position, a second move-to position, and a third move-to position;
a first drive cam configured to move the head mechanism between the first move-to position and the second move-to position; and
a second drive cam configured to move the head mechanism between the second move-to position and the third move-to position; wherein
an amount by which the head mechanism moves over a distance between the second move-to position and the third move-to position is smaller than between the first move-to position and the second move-to position, and
the second drive cam has a smaller outside shape than the first drive cam.

2. The thermal head printer according to claim 1, wherein:
the first move-to position is an evacuation position at which the print head is apart from the platen roller;
the second move-to position is a standby position at which the print head is apart from the platen roller but the print head is closer to the platen roller than at the evacuation position; and
the third move-to position is a printing position at which the print head is pressed against the print paper and holds the print paper together with the platen roller with the print paper interposed therebetween.

3. The thermal head printer according to claim 1, wherein:
the head mechanism is swingable; and
the head mechanism is swung by rotation of the first drive cam and the second drive cam.

4. The thermal head printer according to claim 1, wherein:
the head mechanism has a cam axis;
the first drive cam has a cam groove to which the cam axis of the head mechanism is slidably fitted; and
the cam groove of the first drive cam has an opening through which the cam axis of the head mechanism comes off the cam groove of the first drive cam when the head mechanism is moved by the second drive cam between the second move-to position and the third move-to position.

5. The thermal head printer according to claim 1, wherein:
the head mechanism has a fitting axis;
the second drive cam has a cam sliding part;
the head mechanism has a link mechanism that includes a matable fitting part and also has a cam pin that slidably fits to the cam sliding part of the second drive cam; and
the fitting axis of the head mechanism comes off the fitting part of the link mechanism when the head mechanism is moved by the first drive cam between the first move-to position and the second move-to position.
